(19) United States
(12) Patent Application Publication
(10) Pub. No.: US 2008/0023575 A1
(43) Pub. Date: Jan. 31, 2008

(54) Body Spray Applicator

(75) Inventors: James Trumble, Royal Oak, MI (US); Jos Timmermans, Ortonville, MI (US); Darren Chilton, Royal Oak, MI (US)

Correspondence Address: YOUNG & BASILE, P.C., 3001 WEST BIG BEAVER ROAD, SUITE 624, TROY, MI, 48084, US

(73) Assignee: ALTAIR ENGINEERING, INC., Troy, MI (US)

(21) Appl. No.: 11/831,537

(22) Filed: Jul. 31, 2007

Related U.S. Application Data
(60) Provisional application No. 60/834,517, filed on Jul. 31, 2006.

(51) Int. Cl. B05B 9/03

(52) U.S. Cl. 239/327; 239/302

(57) ABSTRACT

Disclosed herein is a personal body spray applicator having a rectangular shaped body defining a reservoir for containing a liquid. The body has a front face, an opposing back face, and an edge surface adjoining the front face and the back face. A nozzle in fluid communication with the reservoir is provided along the edge surface of the body. An actuator is also positioned along the edge surface of the body and is operable to cause fluid present within the reservoir to be discharged through the nozzle.

### RELATED APPLICATIONS

This application claims benefit of U.S. Provisional Patent Application Ser. No. 60/834,517 filed on Jul. 31, 2006, which is incorporated herein by reference in its entirety.

### FIELD OF THE INVENTION

The present invention relates in general to spray applicators, and more particularly, to a credit card sized spray applicator for applying a personal hygiene or fragrance spray.

### BACKGROUND OF THE INVENTION

The use of personal hygiene or fragrance spray products is well known. In the privacy of one's home, the size and the design of the container holding the personal hygiene or fragrance spray product is not an issue. However, once in public, it is inconvenient to carry around the full sized container. Further, in many instances, it is preferable to keep the personal hygiene product out of sight or disguised from others. Although the initial application of a personal hygiene spray product is usually applied in the morning in the privacy of the user's home, a secondary application of the personal hygiene product might be appropriate during the day or evening after an athletic activity or a club scene where dancing or other vigorous activities occur. Discreet application of the personal hygiene spray would be desirable. Therefore the packaging or container should be small enough to fit in a pocket. In particular in the case of males, who generally carry a limited number of items such as an identification card and folded money, it is preferable that the packaging for a personal spray container is small enough to not further bulk up the pockets or wallet.

### SUMMARY OF THE INVENTION

A personal body spray applicator is provided that includes a rectangular shaped body defining a reservoir for containing a liquid. The body has a front face, an opposing back face, and an edge surface adjoining the front face and the back face. A nozzle in fluid communication with the reservoir is provided along the edge surface of the body. An actuator is also positioned along the edge surface of the body and is operable to cause fluid present within the reservoir to be discharged through the nozzle.

### BRIEF DESCRIPTION OF THE DRAWINGS

FIG. 1 is a perspective view of a personal spray container according to the present invention;

FIG. 2 is a perspective view of the personal spray container storable in a wallet;

FIG. 3 is a perspective view of the personal spray container incorporated into a full size container;

FIG. 4 is a perspective view of the full size container illustrating certain features; and

FIG. 5 is a perspective view of the full size container illustrating removal of the personal spray container there from.

### DETAILED DESCRIPTION

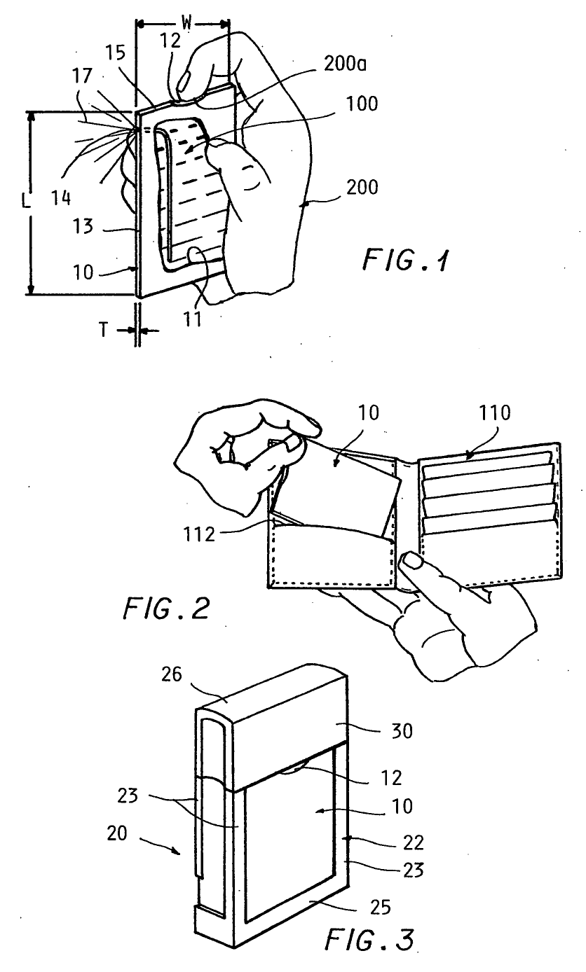

Referring to FIGS. 1-5, a rectangular shaped container 10 is provided having a hollow interior 11 for holding a capacity of approximately 2 cc's of a liquid product for use as a personal hygiene spray or other body spray, such as perfume. The container 10 has a completely closed structure to secure the liquid product 100 therein. The container 10 has a dimension similar to that of a typical credit card or business card, which typically has a length L of approximately 9.0 centimeters and a width W of approximately 5.5 centimeters. The thickness T of the container 10 is preferably less than 5 millimeters. The dimensions of the container 10 enable the personal spray container 10 to be carried in a pocket or in a wallet 110 flap 112, as shown in FIG. 2.

A conventional nozzle 14 and actuator 12 can be located along adjacent edges of the container 10, such as side edge 13 and top edge 15, respectively. The actuator 12 is preferably located along in the width W edge 15 of the container so that the length L edge 13 can be gripped in the user's hand 200. The nozzle 14 can be located along edge 13 along the length L at a right angle from the actuator 12.

When it is desired to dispense the spray, the actuator 12 can be depressed by pressing down on it with the user's finger 200a. Aerosol within the cavity 11 of the container 10 will cause the spray 17 of the personal hygiene product or fragrance to emanate from the nozzle 14.

The container 10 can be discreetly held in the user's hand 200 during application and stored flat in a pocket or wallet 110. While the shape and size is intended to conceal the container 10, the container design is also such that its purpose is not readily apparent.

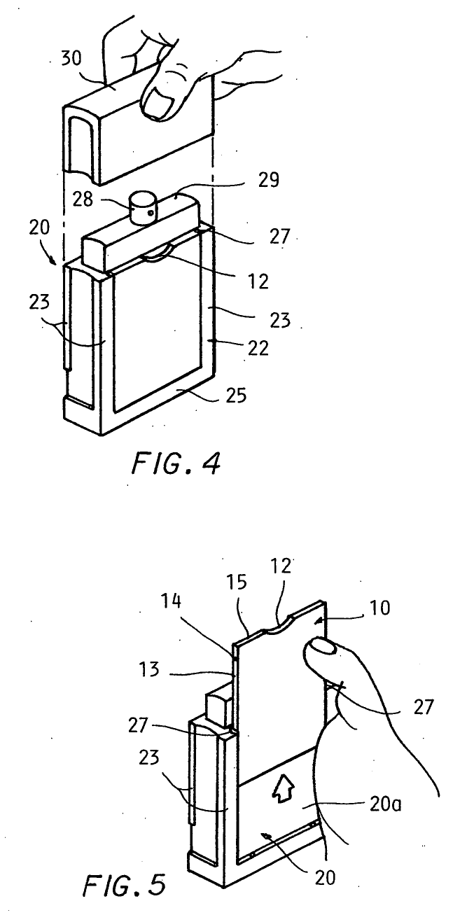

In one aspect the personal spray container 10 may be available as an individual item for sale or as a gift. In another aspect, the personal spray container 10 may be incorporated into the container 20 of a full size product or in an open frame for holding a full size spray container 20. The second aspect is shown in FIGS. 3-5. A frame 22 can be formed by four corner posts 23 wherein adjacent corner posts are connected by an integral base 25 having a bottom surface for receiving the full-size container 20 thereon. The frame 22 is sized such that between two adjacent corner posts 23 is a space for slidably securing the personal spray container 10 there between. The personal spray container 10 forms an outer wall of the full-size product 20. To hold the personal spray container 10 there between, grooves 27 may be formed on inside facing surfaces of the adjacent corner posts 23 for securing the personal spray container 10 until use is required. Another personal spray container 10 may be installed in the opposing side of the frame 23. As seen in FIG. 4, the full-size container 20 may be placed within the frame 22 or may be integrally formed with the frame forming a one piece unit. The full-size container 22 has a conventional nozzle and spray combination 28 for applying the product stored therein. The full sized container 20 also may include a cap 30 that substantially encloses the entire upper surface 29 of the container 20 for covering the nozzle 28 of the full-size container 20, as well as the actuator 12 of the personal spray container 10. The cap 30 is configured to rest on the four corner posts 23 of the frame 23. When the cap 30 is positioned over the full-size container 20, as shown in FIG. 3, inadvertent depression of the actuator 12 can be avoided.

To retrieve the personal spray container 10 from the frame 23 or the side wall of the full sized container 20, the cap 30 is removed from the container 20. Removal of the cap 30 provides access to the personal spray container 10. The personal spray container 10 can be removed from the full sized container 20 by applying an upward sliding motion of the personal spray container 10 along the grooves 27 of container 20. After the contents of the personal spray container 1O is depleted, the personal spray container 10 may be discarded or restored as the outer wall of the full sized container 20. It is evident that the full sized container 20 includes an inner wall 20a positioned behind the outer wall formed by the personal spray container 10. The inner wall 20a, along with the other walls, integrally forms the enclosure for the liquid in the full-size container 20.

The description of the invention is merely exemplary in nature, and thus, variations that do not depart from the gist of the invention are intended to be within the scope of the invention. Such variations are not to be regarded as a departure from the spirit and scope of the invention.

What is claimed is:

1. A liquid spray applicator comprising:
a rectangular shaped body defining a reservoir for containing a liquid, the body having a front face, an opposing back face, and an edge surface adjoining the front face and the back face;
a nozzle located along the edge surface of the body and fluidly connected to the reservoir; and
an actuator attached to the body of the spray applicator along the edge surface, the actuator operable to cause fluid present within the reservoir to pass through the nozzle.

2. The liquid spray applicator of claim 1 further comprising a first edge surface and a second edge surface, wherein the nozzle is located along the first edge surface and the actuator is located along the second edge surface.

3. The liquid spray applicator of claim 2, wherein the first edge surface adjoins the second edge surface.

4. The liquid spray applicator of claim 2, wherein the first edge surface extends substantially perpendicular to the second edge surface.

5. The liquid spray applicator of claim 2, wherein the length of the first edge surface is greater than the length of the second edge surface.

6. The liquid spray applicator of claim 1, wherein no portion of the actuator extends beyond a pair of imaginary planes defined by the front and back faces.

7. The liquid spray applicator of claim 1, wherein no portion of the actuator extends outside an envelope defined by the front face, the back face, and the edge surface of the body.

8. The liquid spray applicator of claim 1, wherein the nozzle is displaced from the actuator.

9. The liquid spray applicator of claim 1, wherein the body has a thickness that is less than its width and length, the body having a maximum thickness of 5 millimeters.

10. A liquid spray applicator comprising:
a first liquid container having a body defining reservoir for receiving a liquid, a nozzle fluidly connected to the reservoir, and an actuator attached to the body and operable to cause fluid from the reservoir to be discharged through the nozzle; and
a second liquid container having a body defining a reservoir for receiving a liquid, a nozzle fluidly connected to the reservoir, and an actuator attached to the body and operable to cause fluid from the reservoir to be discharged through the nozzle, an outer wall of the body at least partially defining an external pocket for receiving the first liquid container, the first liquid container being slidably engageable with the pocket.

11. The liquid spray applicator of claim 10, wherein the first liquid container further includes a rectangular shaped body having a front face, an opposing back face, and an edge surface adjoining the front and back faces, and further wherein the pocket of the second liquid container is at least partially defined by a pair of opposing grooves that slidably engage the edge surface of the first liquid container.

12. The liquid spray applicator of claim 11, wherein at least one of the front and back of the first liquid container is concealed from view when the first liquid container is engaged with the pocket of the second liquid container.

13. The liquid spray applicator of claim 12, wherein at least a portion of one of the front and back faces of the first liquid container is viewable when the first liquid container is engaged with the pocket of the second liquid container.

14. The liquid spray applicator of claim 10 further comprising a cap removeably engageable with and end of the second liquid container for enclosing an upper surface of the second liquid container, at least a portion of the cap being positioned adjacent the actuator of the first liquid container when the first liquid container is engaged with the external pocket of the second liquid container so as to prevent inadvertent actuation of the actuator of the first liquid container.

15. The liquid spray applicator of clam 14, wherein the cap encloses the nozzle and actuator of the second liquid container when the cap is attached to the second liquid container.

16. The liquid spray applicator of claim 14, wherein the first liquid container further includes a body having a front face, an opposing back face, and an edge surface adjoining the front and back faces, the edge surface being positioned adjacent an edge of the cap when the first liquid container is engaged with the pocket of the second liquid container and the cap is attached to the second liquid container.
